(19) United States
(12) Patent Application Publication
(10) Pub. No.: US 2004/0236604 A1
(43) Pub. Date: Nov. 25, 2004

(54) System and method for detecting spatiotemporal clusters

(76) Inventor: Douglas S. McNair, Leawood, KS (US)

Correspondence Address: SHOOK, HARDY & BACON L.L.P., 2555 GRAND BOULEVARD, KANSAS CITY, MO, 64108-2613, US

(21) Appl. No.: 10/744,976

(22) Filed: Dec. 22, 2003

Related U.S. Application Data
(60) Provisional application No. 60/435,159, filed on Dec. 20, 2002.

(51) Int. Cl. G06F 17/60

(52) U.S. Cl. 705/2

(57) ABSTRACT

A method and system suitable for automated surveillance for disease detection and particularly for syndromic information represented in the transaction order records from clinical information systems of hospitals, clinics, and emergency rooms. Patient's findings and conditions expressed as order annotations may be combined with evidence recorded by physicians in a syndromic classifier software application that yields daily counts of proband cases possibly denoting the occurrence of a bioterrorist-caused illness. Techniques from digital signal processing and statistical spatiotemporal image processing are combined in a method that allows for optimization of the parameters of the signal processing and statistical hypothesis testing, prediction for planning and decision-making, and inferencing. Once optimized, the method and system can achieve high-sensitivity high-specificity detection of true occurrences of syndromic illness such as bioterrorism, while avoiding false-alarm signals.

### CROSS-REFERENCE TO RELATED APPLICATIONS

This application claims the benefit of U.S. Provisional Application No. 60/435,159, filed on Dec. 20, 2003.

### STATEMENT REGARDING FEDERALLY SPONSORED RESEARCH OR DEVELOPMENT

Not applicable.

### TECHNICAL FIELD

The present invention relates to a system and method for detecting spatiotemporal clusters.

### BACKGROUND OF THE INVENTION

Disease surveillance-including surveillance for nascent epidemics that could reflect occult acts of bioterrorism-requires the continuous analysis, interpretation, and feedback of systematically collected data. Surveillance can support many activities such as planning and research, but the most important reason for conducting surveillance is to identify changes in population health status that are amenable to control by intervention. The changes, or aberrations, must be detected from data sources that often have a highly variable baseline. Yet, because of the urgency of detecting incipient epidemics, methods for disease surveillance that are distinguished by their practicality, uniformity, and rapidity are preferred to those that may be most accurate and most complete.

Methods for disease surveillance generally have relied on traditional statistical models. (see Stroup, 1994). Such approaches typically take as input disease reports from passive surveillance and generate as output notification of diseases or clinical conditions that may occur above certain thresholds within given geographic areas. Passive surveillance requires health-care personnel to be aware that a clinical situation is “reportable” and to initiate a report to the relevant department of health, and for that department of health to collate and analyze those reports as the reports are received.

The reliability of passive surveillance systems is quite low, since many health-care workers may not even know which conditions are reportable, and may not see an immediate benefit to informing public-health officials of particular diseases or syndromes. Most important, however, passive surveillance is extraordinarily slow. Infected patients typically do not present for treatment until they are significantly ill, and reports of sentinel cases typically do not reach local authorities with any great urgency. By the time passive surveillance systems can detect incipient epidemics, many people will already have been infected and secondary spread of the contagion may already be underway.

The density of data points in space and time also presents difficulties and limitations in the context of traditional predictive systems and inferential statistical methods. When the matrices of data are sparse, traditional methods are noisy and lead to false-alarms at an unacceptable rate. In other instances, traditional methods do not converge to an answer because of the sparsity of values. The matrices are ill-conditioned such that singularities preclude solving the equations at all. When data are sparse, such as when data are organized and analyzed with individual Zipcode-level granularity, drift-type and spatial regression models are sometimes used (Lawson and Denison 2002, p. 214), insofar as there is insufficient data to perform autocorrelation procedures (ibid, p. 222-224). A serious disadvantage of spatial regression modeling is that the class of fitted curves and surfaces is (a) inadequately flexible to accurately represent the range of real-world epidemiologic facts and (b) involves assumptions as to epidemiologic phenomena, and evidence is generally lacking, such that the validity of the assumptions is unsupported and the assumptions may be unjustified.

A further serious difficulty with traditional methods arises in their use of static information regarding populations, to calculate incidence or occurrence rates. While appropriate for chronic disease epidemiology such as studies of cancer and other conditions whose causation often takes years or decades, census population in the denominator causes the methods to be highly insensitive to changes that occur on a time scale of hours to days, such as outbreaks of infectious diseases and toxicity in bioterrorism incidents.

The limitations of current public health methods are well recognized, particularly in light of increasing concern about the possibility of epidemics that may result from acts of biological warfare or bioterrorism. There is thus considerable activity to develop active surveillance systems that may be able to identify incipient epidemics rapidly from primary data available in electronic format in a manner that is not dependent on the acumen of health-care workers to recognize reportable conditions and on their good will to file such reports. Such work requires creative thought about sources of useful and timely data that may diverge from the traditional public-health decision making.

Retrospective analysis of natural disease outbreaks can identify important performance characteristics of potential data sources for detection of bioterrorism. For example, review of data sources related to the large outbreak of waterborne cryptosporidiosis in Milwaukee, Wis., in 1993 showed that emergency-room visits for gastrointestinal symptoms peaked days after the start of the epidemic; school absenteeism peaked at 9 days; laboratory identification of the pathogen, however, did not peak until 15 days after onset of the outbreak (Proctor et al., 1998). In the case of the Milwaukee epidemic, the challenge would have been to identify the increase in emergency-room visits for (nonreportable) gastrointestinal symptoms as quickly as possible.

Increasingly, health-care institutions store a wide range of patient information in electronic medical record systems. Such data typically include the results of laboratory tests (including the results of microbiological cultures), the results of other diagnostic studies, prescriptions and other clinician orders, clinical notes (generally in free text), and codes for diagnoses and procedures. Narrative free-text is also stored with order transaction database records. Such records also include the Zipcode and address information of the individual.

Data available from clinical information systems have been suggested as a rich source of information for disease surveillance. The goal is to identify patterns in the complaints with which patients present to emergency departments, in the conditions of patients admitted to hospitals, and in the prescriptions written for both inpatients and outpatients that could suggest emerging epidemics in the general population as manifested in the subset of patients presenting themselves to health-care organizations. Rather than relying on humans to identify reportable situations, public-health authorities could monitor institutional databases continuously to identify the presence of public-health problems requiring immediate action or further investigation.

There are significant difficulties with this approach, however. Apart from the obvious, surmountable problems of ensuring patient confidentiality, there is the need to translate numerous low-level laboratory values into meaningful abstractions that can drive epidemiological decision making. Public health officials need to be alerted to patterns of patients presenting to emergency departments with fever, not to the particular temperature measurements of specific patients. Furthermore, there is a need to identify complex patterns of findings (e.g., fever plus diarrhea) that may require integration of abstractions of detailed observations stored in the clinical record with additional qualitative patient attributes recorded as diagnosis codes or inferred from narrative text.

Even the simple data stored in electronic patient record systems rarely are in a form that is suitable for direct analysis by traditional statistical approaches. The results of individual microbial cultures, for example, typically need to be interpreted in the context of other cultures that have been taken from the same patient. Primary laboratory data, such as white-blood-cell counts and serum enzyme concentrations, need to be understood in terms of relevant abstractions (e.g., “severe, worsening leukocytosis” and “sustained moderately elevated liver-function tests”) that occur over explicit temporal intervals. Standard statistical methods do not lend themselves to the generation of clinically meaningful temporal abstractions from the myriad point data available in electronic patient patterns that occur in the data over time within specific clinical contexts.

### REFERENCES

Alexander FE, Cuzick J. (1996). Methods for the assessment of disease clusters. In: Elliott P, Cuzick J, English D, Stern R, eds. Geographical and Environmental Epidemiology: Methods for Small-Area Studies. Oxford: Oxford Medical Publications. pp. 238-50.

Alexander FE, Boyle P, eds. (1996). Methods for Investigating Localised Clusters of Disease, IARC Scientific Publication 135. Lyon, France: International Agency for Research on Cancer.

Alexander FE, McKinney P A, Cartwright RA, Ricketts TJ. (1991). Methods of mapping and identifying small clusters of disease with applications to geograhical epidemiology, Geographical Analysis 23:156-173.

Anderson N H, Titterington DM. (1997). Some methods for investigating spatial clustering, with epidemiological applications. Journal Royal Statistical Society, Series A 160:87-105.

Bernardinelli L, Clayton D, Pascutto C, Montmoli C, Ghislandi M. (1995). Bayesian analysis of space-time variation in disease risk. Statistics in Medicine 14:2433-2443.

Bithell J. (1995). The choice of test for detecting raised disease risk near a point source. Statistics in Medicine. 14:2309-2322.

Brown PE, Kaaresen KF, Roberts GO, Tonellato S. (2000). Blur-generated non-separable space-time models. Journal of the Royal Statistical Soc, Series B 62:847-860.

Carrat F, Valleron A. (1992). Epidemiological mapping using the ‘kriging’ method: application to an influenza-like illness epidemic in France. American Journal of Epidemiology. 135:1293-1300.

Cressie N. (1993). Statisticsfor Spatial Data. 2e. London: Chapman & Hall.

Cressie N, Read TRC. (1989). Spatial data analysis of regional counts. Biometrical Journal. 31:699-719.

Diggle P, Elliott P. (1995). Disease risk near point sources: Statistical issues for analyses using individual or spatially aggregated data. Journal of Epideliology and Community Health. 49:S20-S27.

Hills M, Alexander F. (1989). Statistical methods used in assessing the risk of disease near a source of possible environmental pollution: a review. Journal of Royal Statistical Society, Series A. 152:353-363.

Insightful Corp. (2001). SPlus Users' Manual. S+Spatial Stats. Seattle: Insightful Corp.

Jones RH, Zhang Y. (1997). Models for continuous stationary space-time processes. In: Gregoire TG, Brillinger DR, Diggle PJ, Russek-Cohen E, Warren WG, Wolfinger RD, eds. Modelling Longitudinal and Spatially Correlated Data. New York: Springer-Verlag. pp. 289-298.

Knorr-Held L, Besag J. (1998). Modelling risk from a disease in time and space. Statistics in Medicine. 17:2045-2060.

Kulldorf M, Nagarwalla N. (1995). Spatial disease clusters: detection and inference. Statistics in Medicine. 14:799-810.

Kurz L, Benteftifa M H. (1997). Analysis of Variance in Statistical Image Processing. Cambridge: Cambridge University Press.

Lawson A B, Denison D G T, eds. (2002). Spatial Cluster Modelling. Boca Raton: CRC Chapman & Hall.

Lawson A, Biggeri A, Dreassa E. (1999). Edge effects in disease mapping. In: Lawson A, Biggeri A, Böhning D, Lesafre E, Viel J-F, Bertollini R, eds. Disease Mapping and Risk Assessment for Public Health. New York: Wiley. pp. 85-97.

McKee K T, Shields T M, Jenkins P R, Zenilman J M, Glass G E. (2000). Application of geographic information system to the tracking and control of an outbreak of shigellosis. Clinical Infectious Diseases 31:728-33.

O'Connor M J, Grosso W E, Tu S W, Musen M A. (2001). RASTA: A distributed temporal abstraction system to facilitate knowledge-driven monitoring of clinical databases. Proceedings Med Info 2001. Tenth World Congress on Medical Informatics, London, September.

Olsen S, Martuzzi M, Elliott P. (1996). Cluster analysis and disease mapping-why, when, how? A step by step guide. British Medical Journal. 313:863-865.

Proctor M E, Blair KA, et al. (1998). Surveillance data for waterborne illness detection: an assessment following a massive waterbome outbreak of Cryptosporidium infection. Epidemiol Infect 120:43-54.

Quenel P, Dab W. (1998). Influenza A and B epidemic criteria based on time-series analysis of health services surveillance data. European Journal of Epidemiology 14:275-85.

Richardson S. and Green P. (1997). On Bayesian analysis of mixtures with an unknown number of components. Journal of Royal Statistical Society, Series B. 59:731-792.

Schalttmann P, Böhning D. (1993). Mixture models and disease mapping. Statistics in Medicine, 12:1943-1950.

Stroup DF. (1994). Special analytic issues. In: Teutsch, S. M. and Churchill, R. E., editors. Principles and Practice of Public Health Surveillance. New York: Oxford University Press. pp. 136-149.

Stroup D F, Thacker S B. (1993). A Bayesian approach to the detection of aberrations in public health surveillance data. Epidemiology 4:435-43.

Waller L, Carlin B, Xia H, Gelfand A. (1997). Hierarchical spatio-temporal mapping of disease rates. Journal of the American Statistical Association. 92:607-617.

Webster R, Oliver M, Muir K, Mann J. (1994). Kriging the local risk of a rare disease from a register of diagnoses. Geographical Analysis. 26:168-185.

Xia H, Carlin BP. (1998). Spatiotemporal models with erros in covariates. Statistics in Med 17:2025-2043.

### SUMMARY OF THE INVENTION

The present invention is an automated method for analysis of electronic patient-record data that uses medical knowledge to infer high-level patterns from primary data. The explicit encoding of knowledge for use by the computer allows for identification of associations among the data and of temporal trends that cannot be detected by standard statistical approaches.

Unlike standard statistical techniques such as time-series analysis (Quenel and Dab, 1998) or Kalman filtering (Stroup and Thacker, 1993), the present invention combines a wide range of quantitative and qualitative data when performing the spatio-temporal abstraction process. The present invention uses clinical knowledge encoded for the computer to recognize that concomitant fever and diarrhea (both qualitative abstractions) can combine to form another qualitative abstraction called constitutional signs. In turn, state abstraction allows the concurrent presence of anemia, leukocytosis, and thrombocytopenia to be abstracted into episodes of syndromic illness. Performing each of these state abstractions requires the method of the present invention to have access to clinical knowledge that defines the relationships between the different descriptors (e.g., that low hematocrit is called anemia) as well as expectations for data value in different contexts (e.g., what constitutes a “low” hematocrit under ordinary circumstances; what constitutes a “low” hematocrit in the setting of chronic renal failure).

Standard approaches to disease surveillance typically use passive methods that are not well suited to rapid detection of changes in disease patterns. Moreover, even when it is possible to monitor primary data sources in real time, traditional statistical techniques do not allow epidemiologists to evaluate rich data sources, such as electronic patient records, where detailed clinical knowledge is needed to determine how the data should be interpreted and viewed abstractly over time. The power of artificial-intelligence approaches, such as the present invention, is that the necessary clinical knowledge can be encoded directly in the computer and brought to bear in a principled way to detect automatically a wide range of high-level patterns. Although statistical techniques can “let the data speak for themselves,” knowledge-based techniques have the unique ability to use qualitative data, contextual information, and explicit relationships among the data elements to make inferences about the data that simply cannot be performed when using standard approaches.

Particularly when performing surveillance for bioterrorism, the low signal-to-noise ratio in most available data sources requires the ability to use contextual information and the presence of concomitant conditions to adjust the thresholds used for identifying abnormal patterns. At the same time, the high covariance among many data elements would favor the use of automated monitoring systems that can use domain knowledge to form appropriate abstractions that avoid over-counting of interdependent data streams.

For some epidemics, there will be signals detectable from emergency-room visits and possible hospital admissions several days before clinical laboratories begin to report positive cultures (Proctor et al., 1988). The ability to use clinical data from emergency rooms and order transactions processed by hospitals in an effective manner requires the ability to generate useful spatiotemporal abstractions of those data across patient groups. Each such database record is linked to Zipcode information of the institution submitting the record and also to Zipcode information of the patient to whom the record pertains.

Key to any warning system is the ability to detect the threat as soon as possible after it has been initiated. Once a threat has been initiated with a microbe or toxin, the local exposures to the offending particles are likely to be high, resulting in transient increases in daily incidence of syndromic states observed by nearby health care institutions. Accordingly, near the release point, classification/identification becomes a much-simplified task because of the expected spatiotemporal autocorrelation of proband cases.

Finding a suitable signal becomes far simpler if detection is prompt and close to the release, an objective of the present invention. Secondary objectives are devising suitable immunity to false or equivocal classifications, and optimizing the sensitivity and specificity of the spatiotemporal pattern detector. In a large collection of positively identified affected persons (or probands) such as may occur daily on the state or provincial scale, the probability of misclassifying the entire ensemble, and thus the detected event itself, becomes vanishingly small. It is a major objective of the present invention to focus “on the forest” of neighboring counties, so to speak, rather than a particular “tree” (city or Zipcode). This is valuable insofar as public health interventions and homeland security decision-making predominantly are conducted on state and national levels. Conducting them in spatially finer-grained jurisdictions carries considerable risk of false-reassurance and, perhaps more troublesome in terms of societal perceptions and wasted resources associated with false-alarms.

The model of the present invention is non-parametric and does not require assumptions about the statistical distributions of the underlying stochastic spatiotemporal processes that give rise to the count data. Space-time analysis is performed under the presumption that the movement of susceptible populations is relatively homogeneous and exhibits a locality-of-reference and autocorrelation on a timescale of one to several days, a timescale comparable to the incubation period and rate of emergence of symptoms and access by affected individuals of the health system in their area. Under the statistical null hypothesis, it is assumed that proband cases that are geographically close to one another occur at random times throughout an outbreak. Rejection of the null hypothesis based on analysis of exponential moving average (EMA) signals would indicate that cases that were geographically close to one another also occurred closer together in time than they would have occurred by chance alone.

For model development and evaluation of the method, the null model was generated with approximate randomization of the Mantel product (Alexander and Cuzick 1996) by permutation of the space-time matrix of Tennessee counties and reporting days for 1000 trials. Distances between cases were calculated as Euclidean distance between the locations for latitude and longitude of the centroids of the counties of the patients' home addresses, regardless of the county in which the institution processing the transactions and reporting each case was located. In this way, the system and method takes into account the prevailing regimes of commuting and other local travel patterns, which in turn are germane to risk assessment and public health decision-making and communications. The geographic locations were established as state plane coordinates (North American Datum 1983).

As known in the art, models can be extended to handle disease incidence data which has a temporal as well as a spatial dimension (Bernardinelli et al, 1995; Knorr-Held and Besag, 1998; Waller et al, 1997). Special problems introduced by edge effects in disease mapping have been discussed by Lawson et al (1999). Bayesian mixture or latent structure models have also been used in disease mapping as an alternative to the more conventional models discussed earlier (e.g., Schalttmann et al, 1993; Richardson and Green, 1997). Other studies have also considered the application of geostatistical interpolation models (primarily variants of kriging) to the analysis of disease rates (e.g. Carrat et al, 1992; Webster et al, 1994).

Disease clustering studies seek to establish significant ‘unexpected’ elevated risk of a disease either in space, or in space and time. Such localized ‘clusters’ could arise from many factors—e.g. an unidentified infectious agent, localized pollution sources, or localized common treatment side-effects (such as might occur with widespread self-medication with antibiotics during periods of suspicion or anticipation of bioterrorism attacks, where the antibiotics may themselves produce syndromic signs and symptoms, such as abdominal discomfort, nausea, diarrhea, etc.). There are several comprehensive general reviews of the area (e.g. Hills and Alexander, 1989; Alexander et al, 1991; Bithell, 1995; Kulldorf and Nagarwalla, 1995; Alexander and Boyle, 1996; Olsen et al, 1996; Anderson and Titterington, 1997). In general disease cluster studies may seek to investigate a ‘general tendency to cluster’ (no pre-specified locations or number of suspected hazards) or be concerned with ‘focused clustering’ (pre-specified number and locations for putative hazards). Disease clustering studies may involve either case event or aggregated data (see Diggle and Elliott, 1995, for a discussion of the relative merits). In both cases, known population heterogeneity and other covariates must be allowed for, along with any natural tendency to cluster through effects induced by data aggregation or inadequately measured covariates.

One computing environment commonly employed in geographical epidemiology (as in many other areas of statistical analysis) is the S-PLUS® statistical computing language, a product of Insightful, Inc. A number of ‘add on’ S-PLUS packages particularly oriented to spatial applications are also available, in particular S+SPATIAL™ (Insightful, Inc.) and S+GEOSTAT™ (Geospatial and Statistical Data Center, University of Virginia). The former includes several general-purpose routines for spatial analysis, including point pattern analysis, some forms of spatial regression and simple kriging; whilst the latter is oriented to geostatistical modeling. The preferred embodiment of the present invention utilizes nearest-neighbor, kriging, and Moran I statistic algorithms of S-PLUS or equivalent.

S-PLUS does not provide for Markov Chain Monte Carlo (MCMC) simulation methods. MCMC functionality in the preferred embodiment is provided by BUGS (Bayesian inference using Gibbs sampling) software or, more recently, WinBUGS software. These packages are able to implement many of the Bayesian models discussed in earlier sections of the present invention. A link between BUGS and S-PLUS, known as CODA (Convergence Diagnostic and Output Analysis) software, enables results from BUGS simulations to be transferred to S-PLUS for subsequent analysis. BUGS, WinBUGS and CODA software are available from MRC Biostatics and the Imperial College School of Medicine at St. Mary's, London.

In accordance with the invention, a method and system mitigating the limitations enumerated above and suitable for a syndromic illness detection procedure areprovided. The invention is intended to be used either by the epidemiologist in the state Department of Public Health or by other state or national officials responsible for homeland security. Several embodiments feature a recursively calculated exponential moving average (EMA) that is variance-stabilized and normalized, for effecting daily deliveries of decision-support interpretations and inferential statistical probability results with small lag in the time-domain, yet possessing high signal-to-noise ratio and noise-immunity that is robust against practical anomalies that occur in syndromic data reporting and electronic transmission of data.

Additional advantages and novel features of the invention will be set forth in part in a description which follows, and in part will become apparent to those skilled in the art upon examination of the following, or may be learned by practice of the invention.

### BRIEF DESCRIPTION OF THE DRAWINGS

The present invention is described in detail below with reference to the attached drawing figures, wherein:

FIG. 1A is a flow chart of the method for developing, optimizing, and validating the algorithm using Markov Chain Monte Carlo (MCMC) simulations;

FIG. 1B is a schematic diagram of one example embodiment of a plurality of possible server and network architecture embodiments, implementing the said method;

FIG. 1C is a flow chart of the method for evaluating county-level data for one state or province, or a plurality of states or provinces, and for inferential hypothesis-testing, detecting occurrences of syndromic illness outbreaks;

FIG. 2 is a diagram of the counties of an example U.S. state that formed the basis for evaluation and simulation of the performance of the development, validation, and runtime use of the method, Tennessee.

FIG. 3 is a diagram of Tennessee cities and the latitude and longitude bounding-box utilized for the example evaluation and simulations.

FIG. 4A,B are contour and surface plots of example scenario 00.

FIG. 5A,B,C are contour and surface plots of example scenario 01.

FIG. 6A,B,C are contour and surface plots of example scenario 02.

FIG. 7A,B,C are contour and surface plots of example scenario 03.

FIG. 8A,B,C are contour and surface plots of example scenario 04.

FIG. 9A,B,C are contour and surface plots of example scenario 05.

FIG. 10A,B are contour and surface plots of example scenario 06.

FIG. 11A,B are contour and surface plots of example scenario 07.

### DETAILED DESCRIPTION OF THE INVENTION

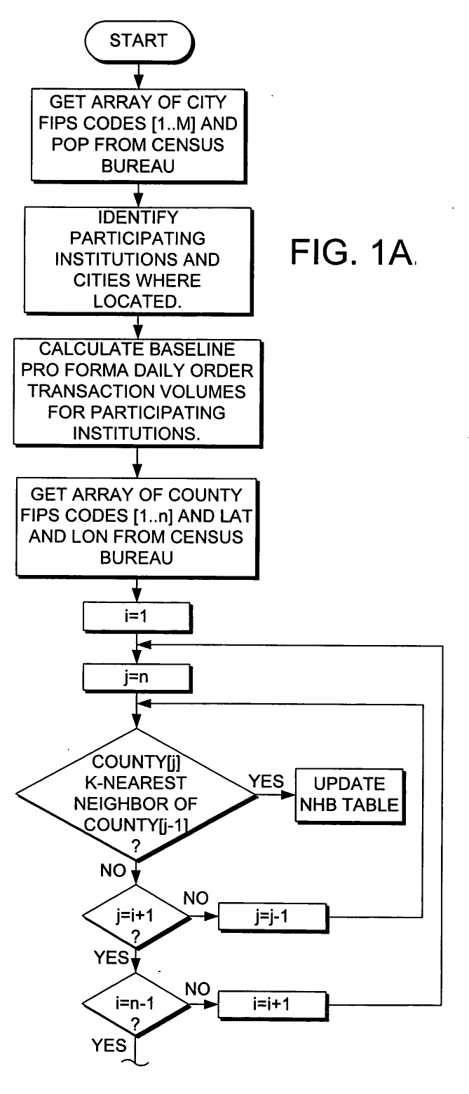

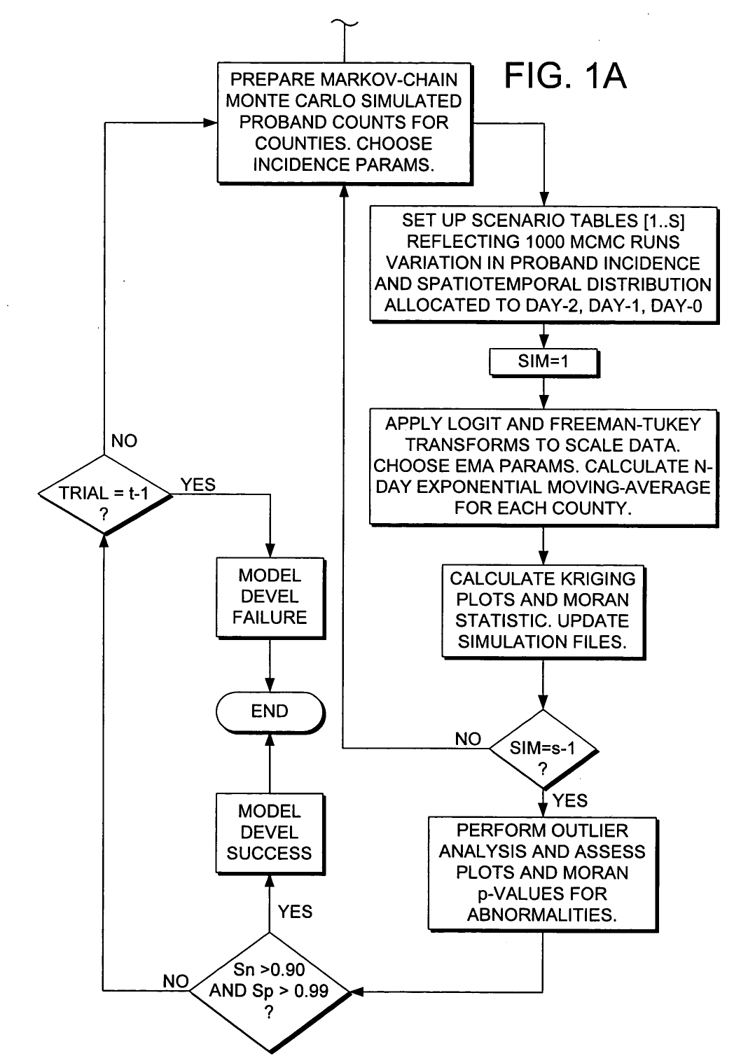

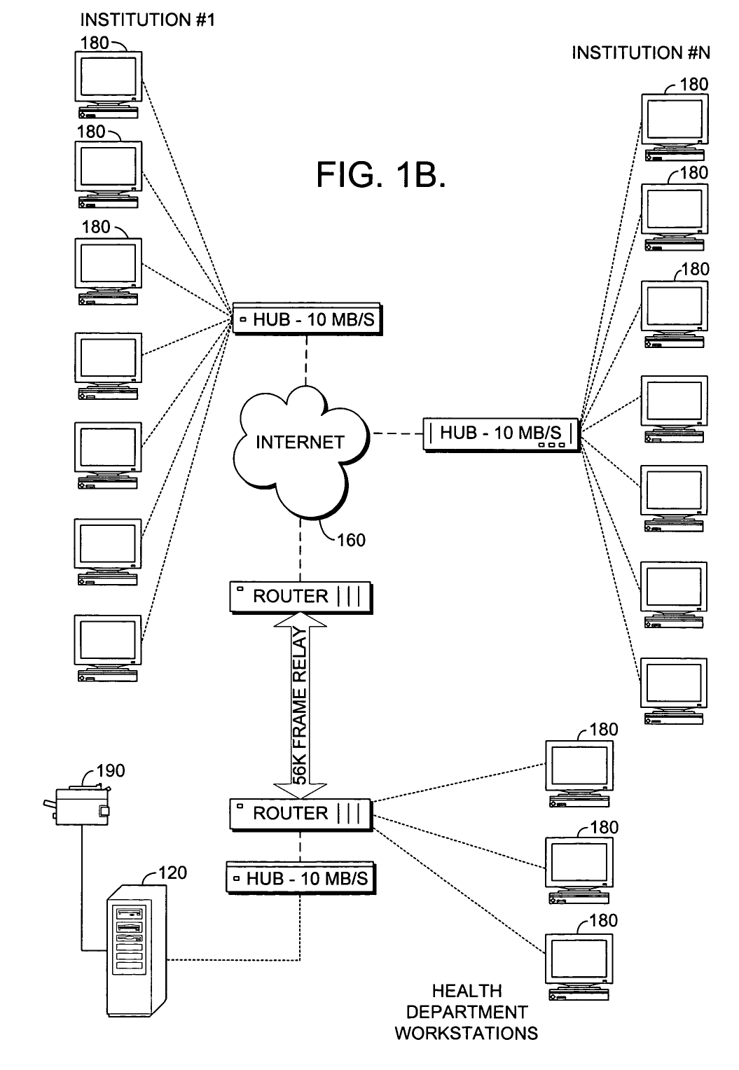

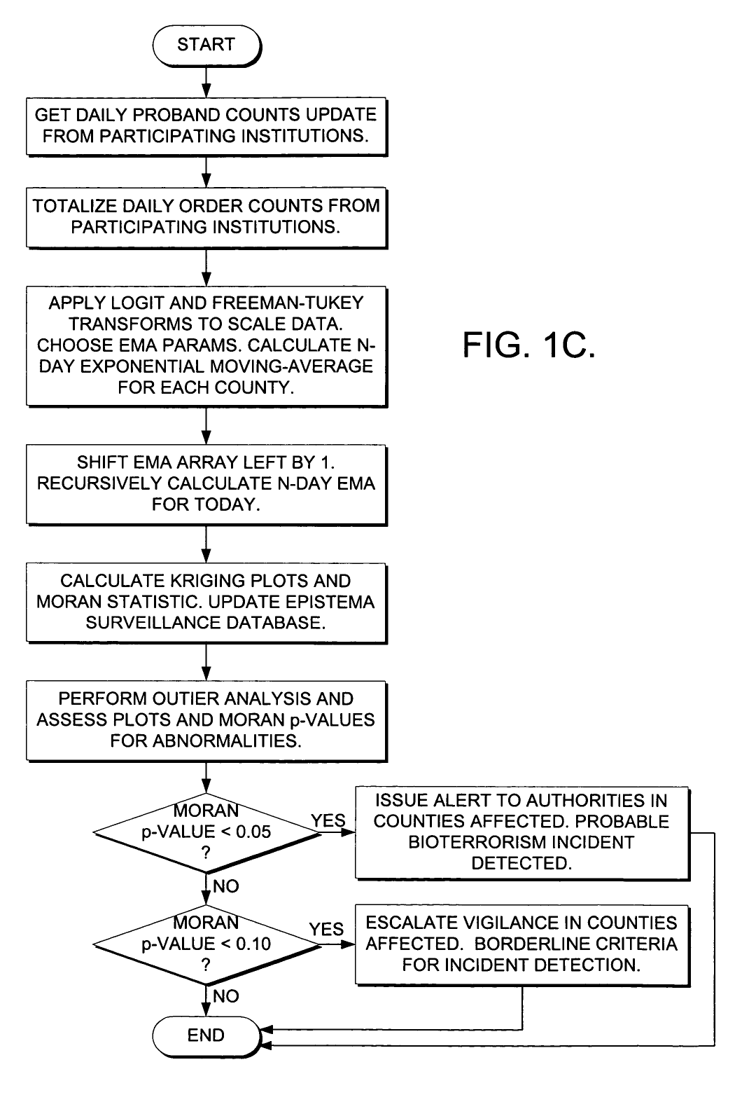

Referring now to FIG. 1A, a diagram is shown of the elements comprising the method and system for generating the spatiotemporal pattern detector and verifying and validating whether such a detector achieves statistical sensitivity and specificity in the intended geographic region of deployment, sufficient for satisfactory performance in the use for classifying possible occurrences of outbreaks of syndromic illness, including those due to bioterrorism attacks. To be effective, such a detector must be sufficiently free of undue influence of individual reporting sites; must be longitudinally stable despite changes in the number of reporting sites or the entry into, or exit from, participation by specific individual reporting sites; and must be robust against secular trends such as are endemic among such reporting sites due to seasonal patterns of illness or trends that arise from changes in the organizational affiliations, business success, referrals intensity, and other logistical factors.

City-level and County-level FIPS codes and latitude and longitude coordinates necessary for composing the surveillance database are available from government public-domain sources. Baseline order activity is captured from reporting sites for a period not less than 30 days, and aggregated for the purpose of establishing pro form a daily rates of order transaction incidence. Transactions comprising the signal for the syndromic detector (e.g., order free-text comment narrative, describing symptoms or reason for visit or exam) are also captured. K-nearest neighbor table generation is performed automatically by standard software methods known to those practiced in the art, and in the preferred embodiment are so calculated using S+SPATIAL software. Markov Chain Monte Carlo tables are generated by standard Bayes Gibbs Sampler methods utilizing a Poisson distribution for point-events, and in the preferred embodiment are so calculated using WinBUGS software.

The standardized incidence ratio, of daily syndrome-positive probands πᵢ to the current days' [orders] transaction incidence Ωᵢ, is calculated by aggregating the counts for institutions in each county, for each of the i reporting counties. The Freeman-Tukey transform (Cressie and Read, 1989) is then calculated as:

τᵢ=\sqrt{1000}[\sqrt{πᵢ/Ωᵢ}+\sqrt{(+πᵢ)/Ωᵢ}]

The Freeman-Tukey transformation of each reporting unit's standardized daily syndromic incidence ratio is employed to normalize the variance and to prevent excessive sensitivity to single-count reports from reporting units having small population.

Next, the values are normalized via a logit transformation as:

λᵢ2*(exp(τᵢ)/(1+exp (τᵢ))−0.5)

The logit transformation is employed to scale the detector's dynamic range automatically to lie on the interval between 0 and 1. Such normalization confers upon the detector immunities against false-negative and false-positive interpretations, against anisotropy of sensitivity, and against spurious interpretations under conditions of changes in reporting units over time. Normalization also facilitates uniformity of user interpretation of graphical presentations of the data.

The multi-period discrete-time exponential moving average (EMA) is then recursively computed as:

μₜ=μₜ−1+(k*(λₜ−μₜ−1)), k=2/(N+1)

where N is the number of periods over which the signal is to be averaged. Preferably, the period of N days corresponds to the epidemiologically optimized value reflecting the statistical distributions of incubation periods of the likely agents of bioterrorism, which comprise a number of bacterial and virologic agents and toxins. Optimization of N requires exploratory data analysis to localize and calibrate the model for each geographic area such as each state or province, to insure acceptable sensitivity, specificity, and receiver operating characteristic (ROC) performance. In a preferred embodiment, N=3 days. The Moran I statistic is calculated in the manner familiar to those experienced in the art (see Cressie 1883, and Lawson and Denison 2002), and the p-value is computed for each spatiotemporal pattern in each simulation trial scenario. The simulations' results are aggregated and the sensitivity and specificity of the detector for the chosen values of detector parameters, including N, are calculated. Model sensitivity greater than 90% and model specificity greater than 99% are regarded as acceptable for the intended acute public health surveillance purpose.

Referring now to FIG. 1B, a diagram is shown of the elements comprising the method and system for deploying a properly parametrized, verified, and validated detection and classification system. Daily data feeds are transmitted by secure client-server communications channels, such that the method of the present invention and user-interface displays and reports can be instantiated on a centralized server, typically located within the state Department of Health.

Specifically, an exemplary system for implementing the invention includes a general purpose computing device in the form of server and database 120. Components of server may include, but are not limited to, a processing unit, internal system memory, and a suitable system bus for coupling various system components of the server with the database. The system bus may be any of several types of bus structures, including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The server of server/database 1200 typically includes therein or has access to a variety of computer readable media, for instance, the database component of the server/database. Computer readable media can be any available media that can be accessed by server, and includes both volatile and nonvolatile media, removable and nonremovable media. By way of example, and not limitation, computer readable media may comprise computer storage media and communication media. Computer storage media may be implemented in any method or technology for storage of information, such as computer readable instructions, data structures, program modules or other data. Computer storage media includes, but is not limited to, RAM, ROM, EEPROM, flash memory or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the server. Communication media typically embodies computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared and other wireless media. Combinations of any of the above should also be included within the scope of computer readable media.

The computer storage media, including the database, discussed above and illustrated as part of database/server 120 in FIG. 1B, provide storage of computer readable instructions, data structures, program modules, and other data for server. Server may operate in a computer network 160 using logical connections to one or more remote computers 180. Remote computers 180 can be located at a variety of locations in a medical and government environments, for example, but not limited to, hospitals, other inpatient settings, testing labs, medical billing and financial offices, and hospital administration. As illustrated in FIG. 1B, in a preferred embodiment, remote computers 180 are located at clinical institutions at which primary clinical results are received, and health departments at the local, state or national level. Each remote computer 180 may be a personal computer, server, router, a network PC, an interfaced instrument, a peer device or other common network node, and may include some or all of the elements described above relative to server of server/database 120. Computer network 160 may be a local area network (LAN) and/or a wide area network (WAN), but may also include other networks. Such networking environments are commonplace in offices, enterprise-wide computer networks, intranets and the Internet (as displayed in the preferred embodiment of FIG. 1B). When utilized in a WAN networking environment, the server may include a modem or other means for establishing communications over the WAN, such as the Internet. In a networked environment, program modules or portions thereof may be stored in the server/database cluster 120, or on any of the remote computers 180. For example, and not limitation, various application programs may reside on the memory associated with any one or all of remote computers 180. It will be appreciated that the network connections shown are exemplary and other means of establishing a communications link between the computers may be used.

By way of example, a user may enter commands and information into server of server/database 120 or convey commands and information to the server via remote computers 180 through input devices, such as keyboards or pointing devices, commonly referred to as a mouse, trackball, or touch pad. Other input devices may include accepting data from an interface or logic system, microphone, satellite dish, scanner or the like. The server of server/database 160 and/or remote computers 180 may have any sort of display device, for instance, a monitor. In addition to a monitor, the server and/or computers 180 may also include other peripheral output devices, such as speakers and printers. In a preferred embodiment, a network printer 190 is associated with the server/database 120.

Although many other internal components of server 12 and computers 18 are not shown, those of ordinary skill in the art will appreciate that such components and their interconnection are well known. Accordingly, additional details concerning the internal construction of server/database 120 and computers 180 need not be disclosed in connection with the present invention.

Referring now to FIG. 1C, a diagram is shown of the elements comprising the method and system for daily operation of the system, wherein appropriately trained and qualified epidemiologists use the system of the present invention to process daily inbound transmissions from participating reporting sites; perform Freeman-Tukey, logit, and EMA transformations of the data; and automatically generate Moran I statistic and kriging plots for interpretation. In FIG. 1C, the database is identifed as the EPISTEMA™ surveillance database. If the p-level for a given day's processing of submitted data is less than p=0.05, the result is statistically significant and warrants notification of authorities for subsequent decision-making and intervention. If the p-level for a given day's processing of submitted data is greater than or equal to 0.05 but less than p=0.10, the result is statistically borderline-significant and warrants escalation of vigilance during the next 24 hours, anticipating subsequent decision-making and possible intervention depending on proband and order count transmissions received on the following day.

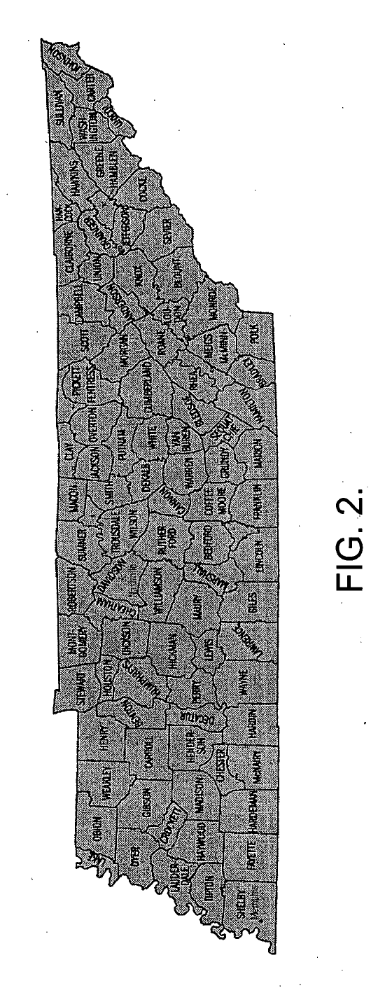

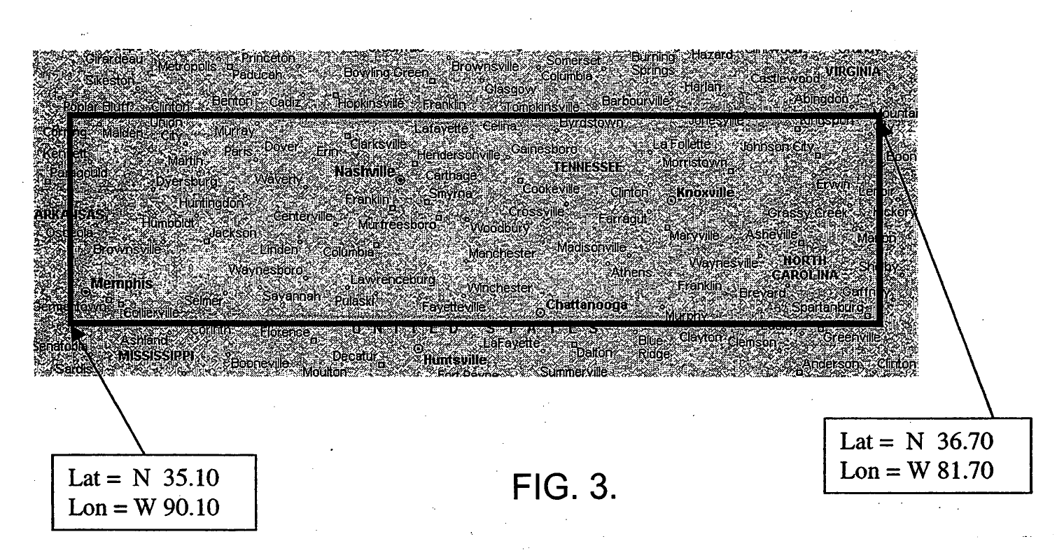

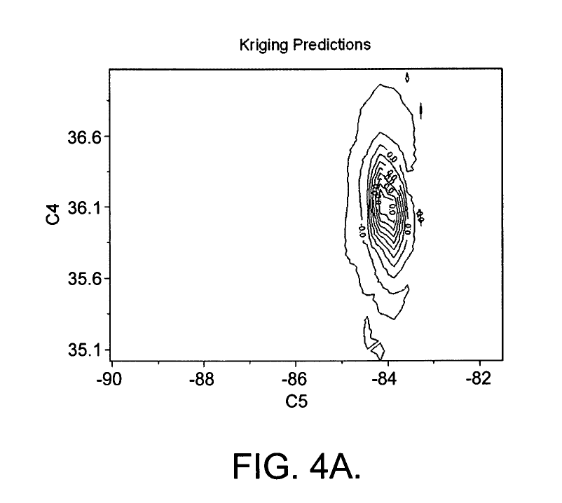

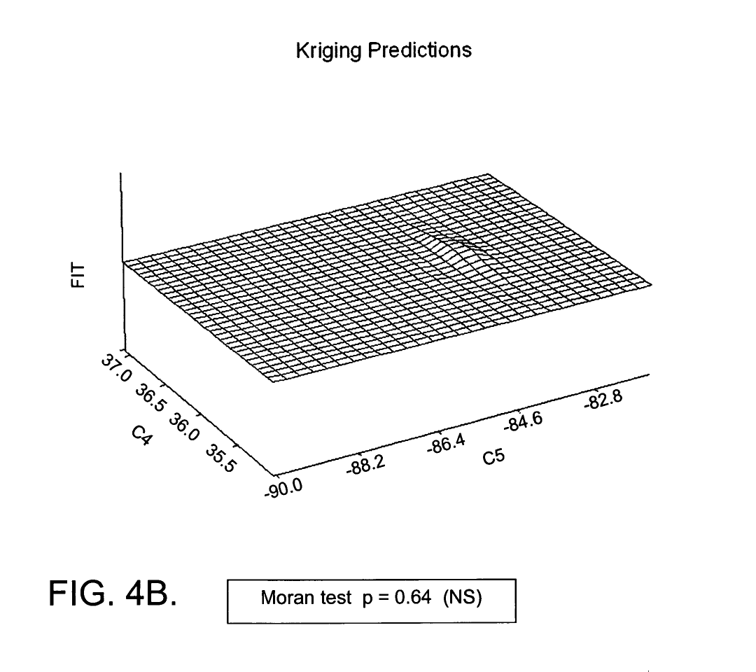

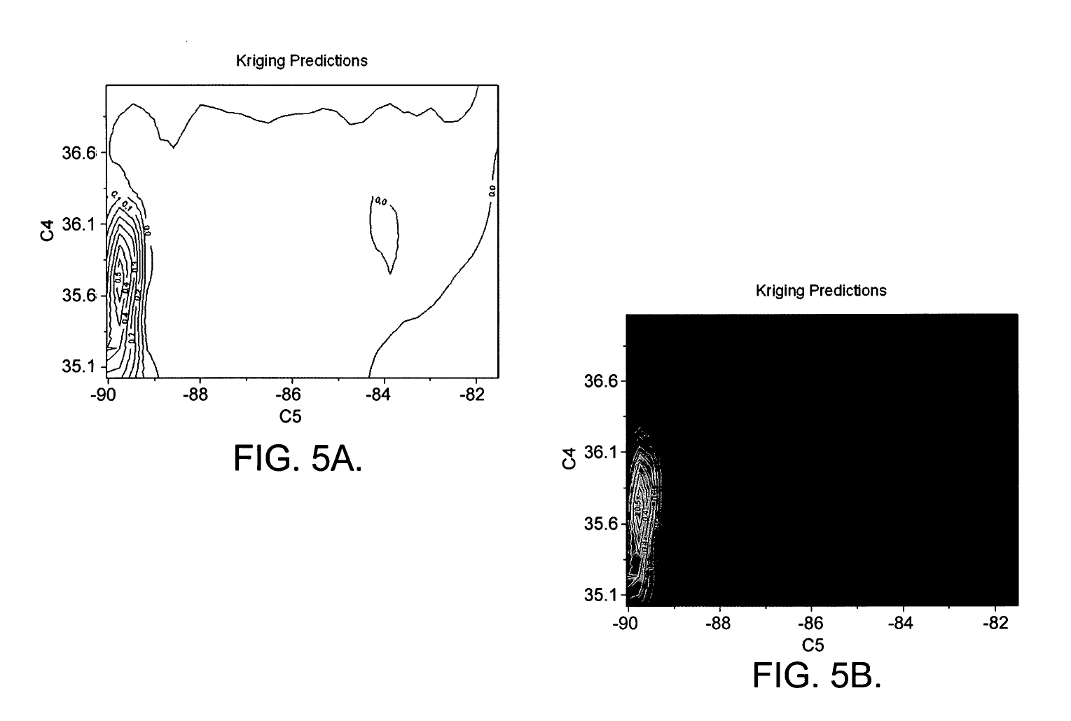

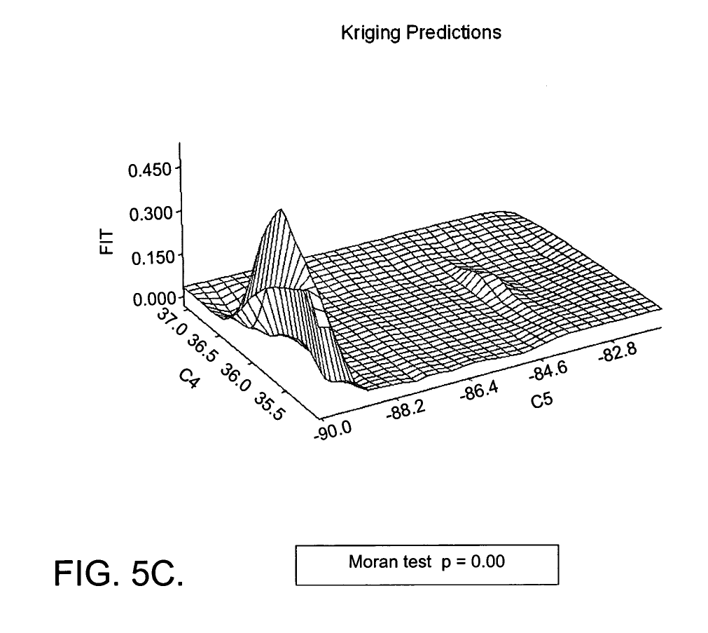

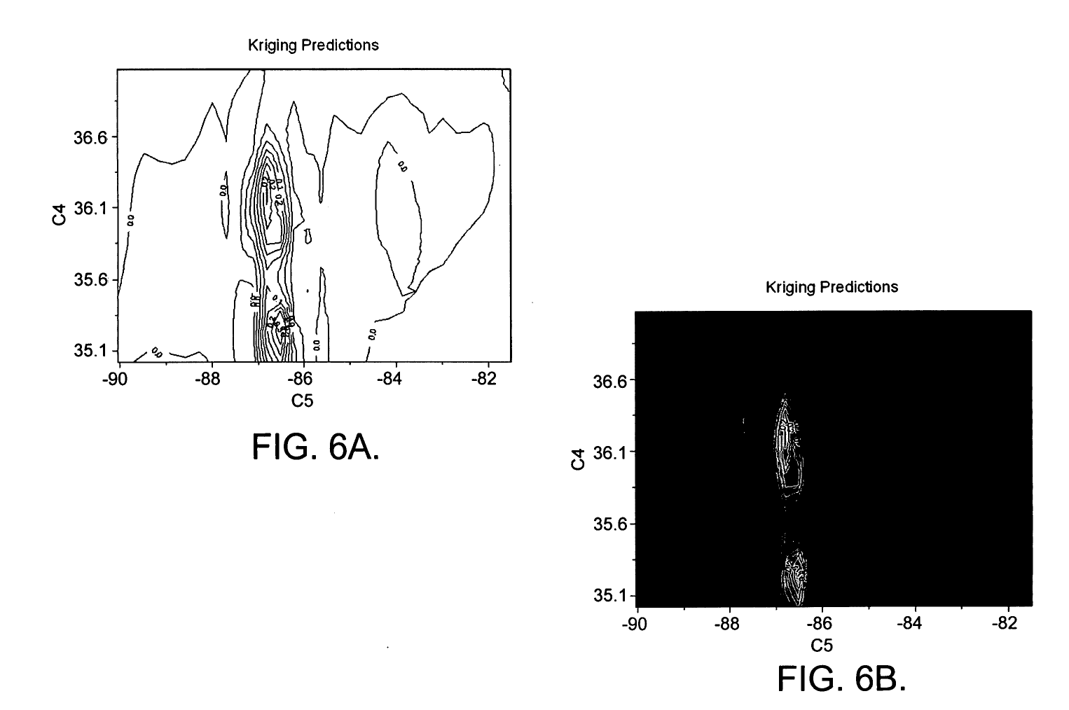

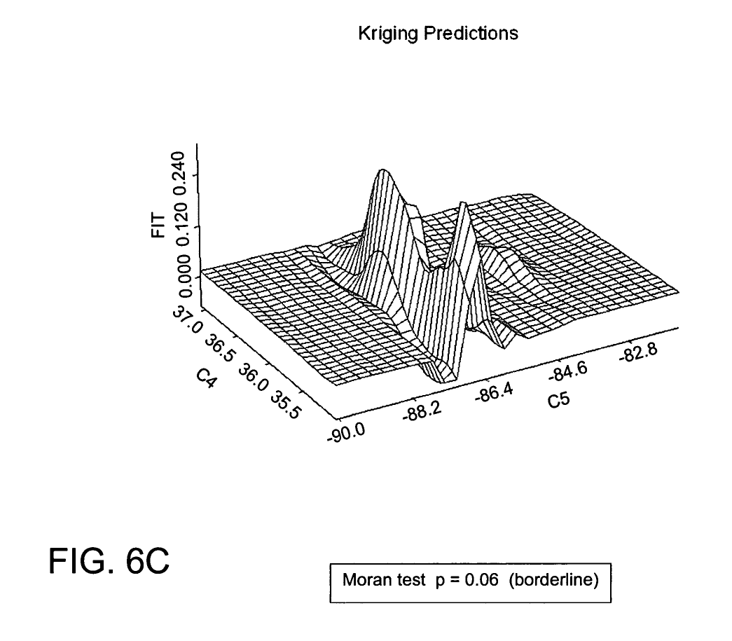

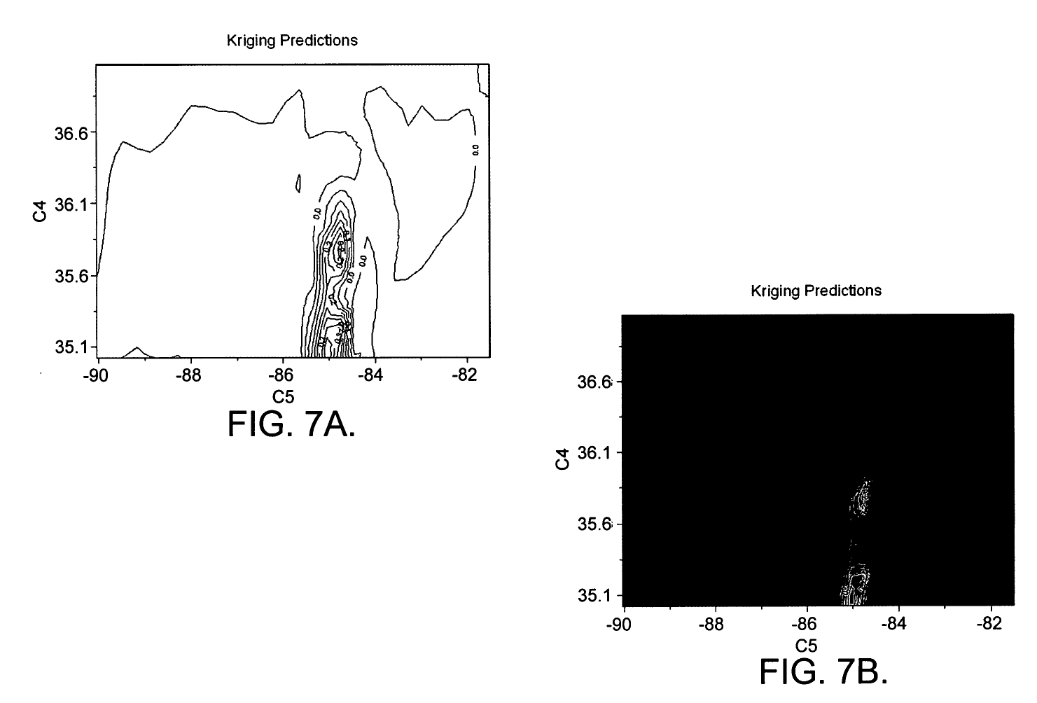

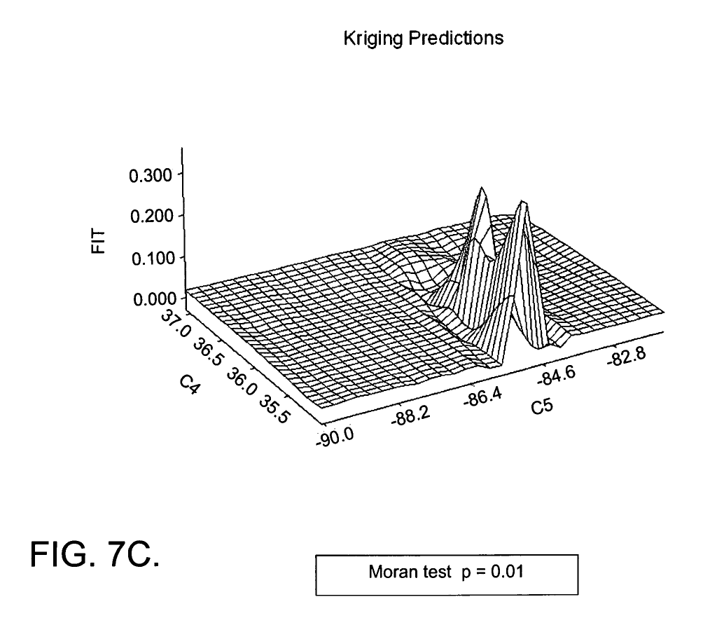

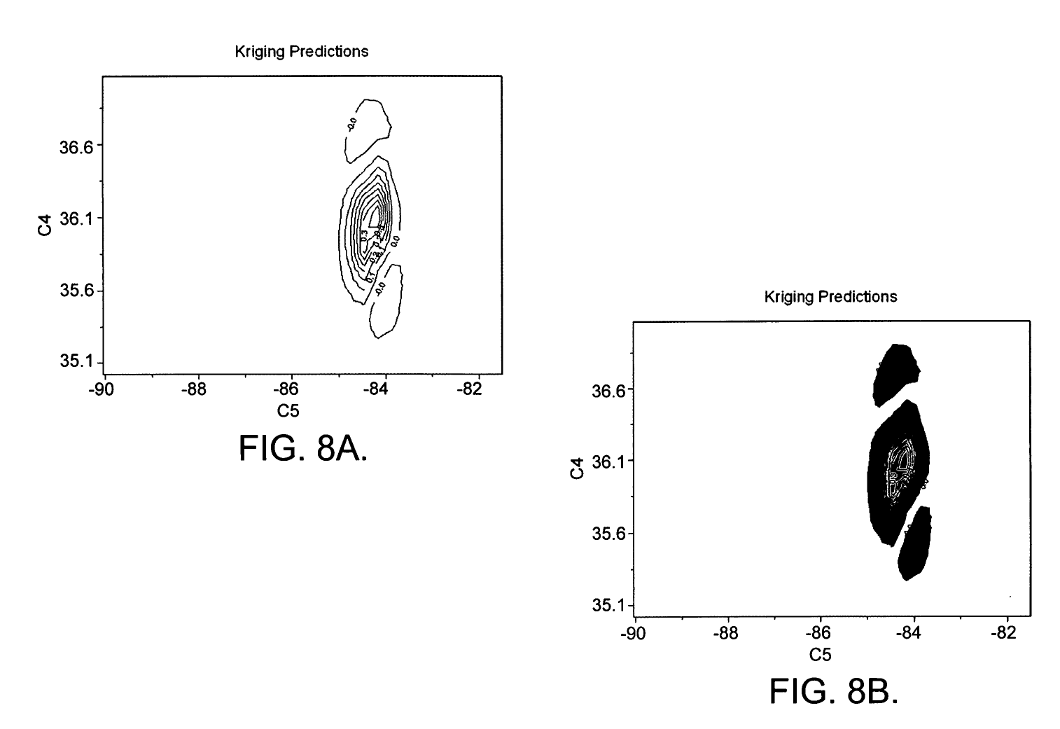

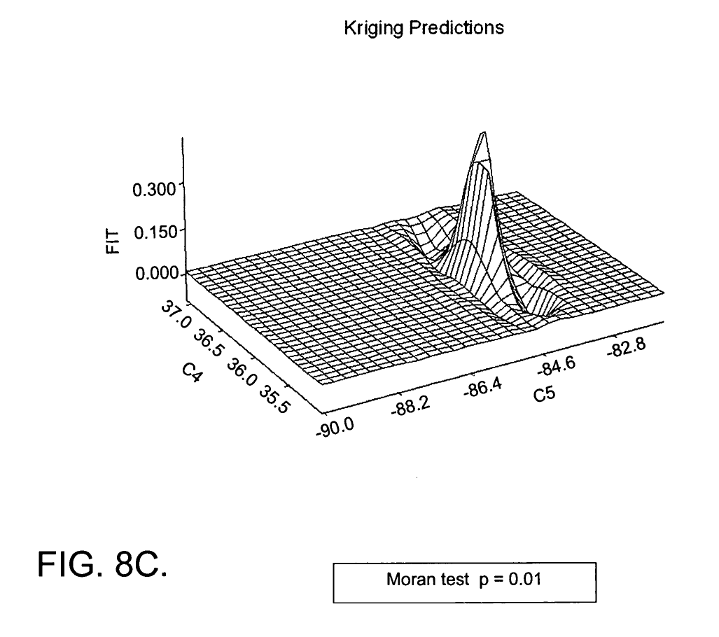

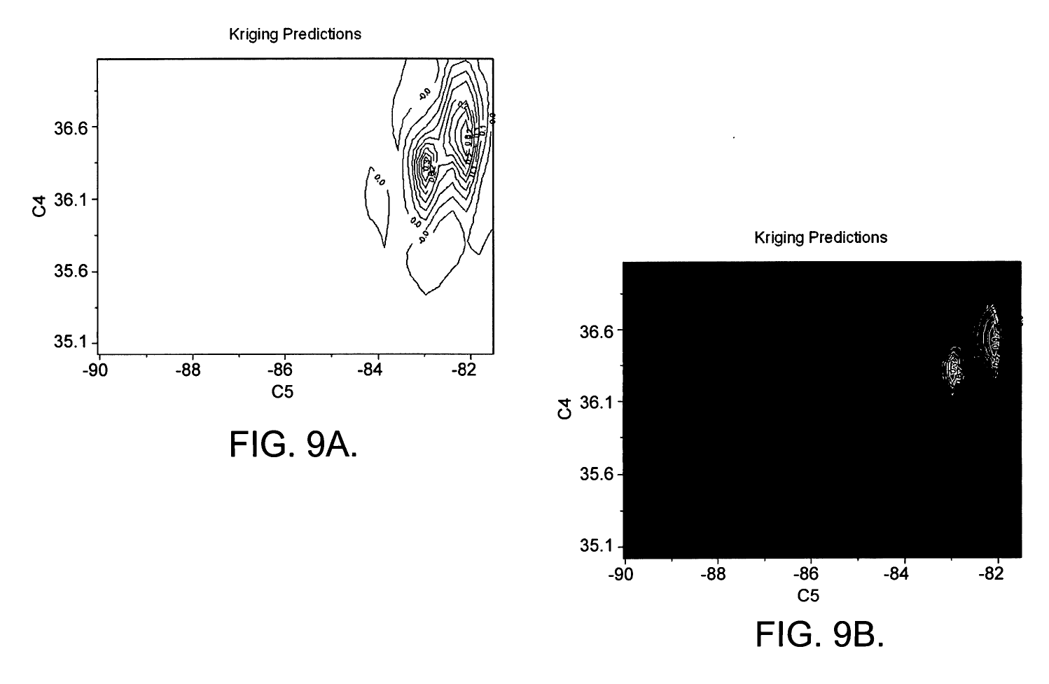

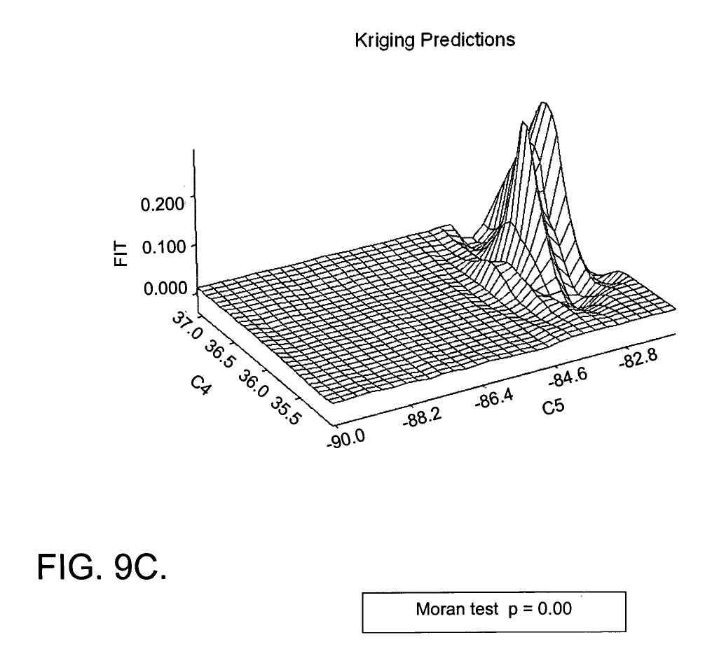

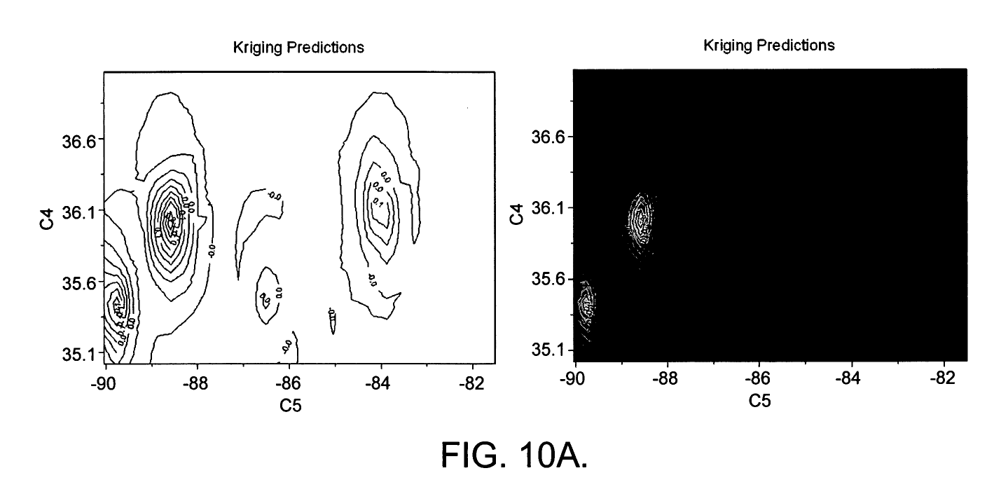

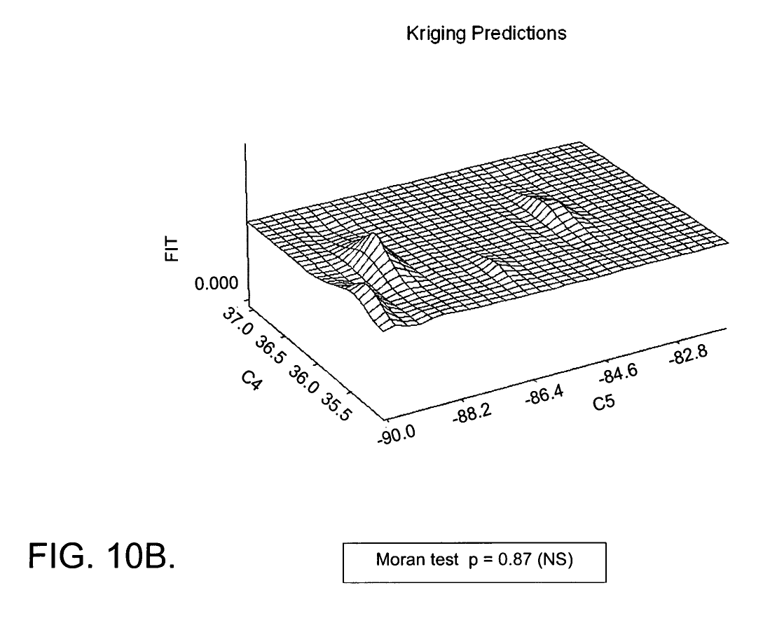

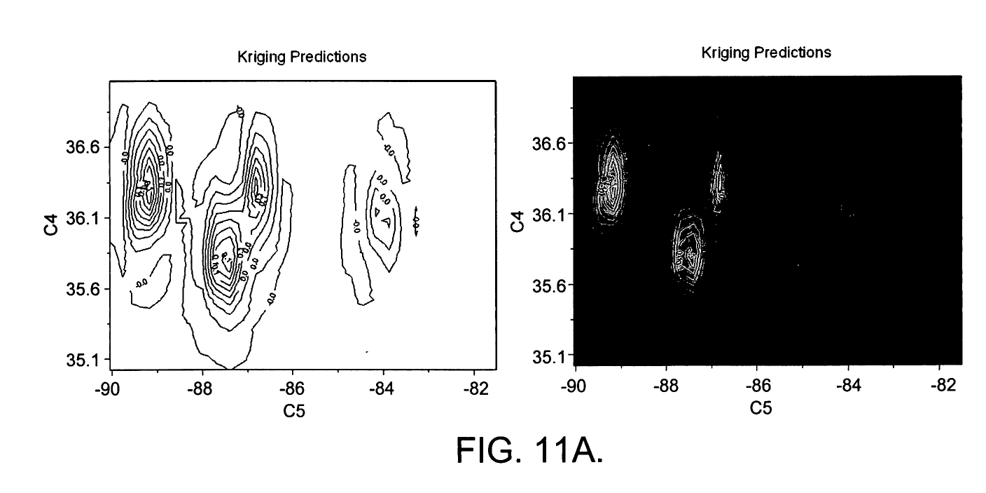

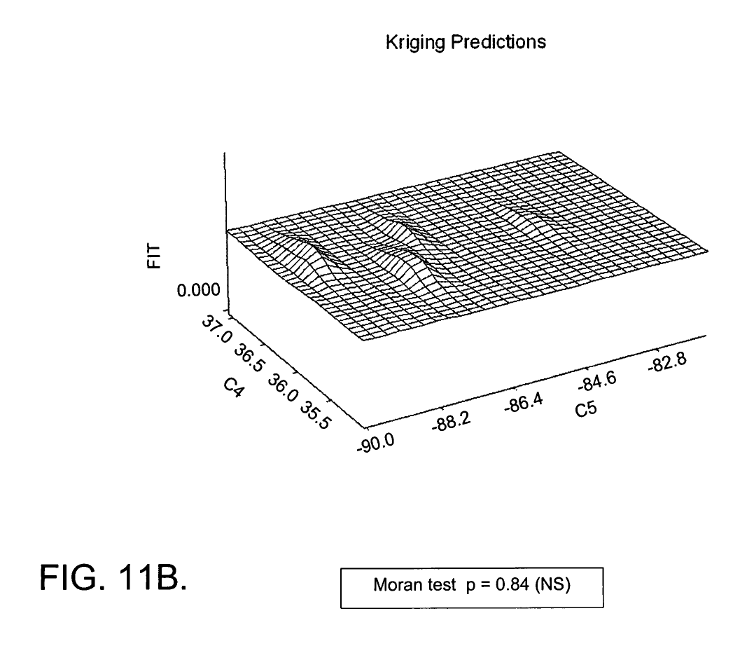

Referring now to FIGS. 2 and 3, diagrams are shown of the State of Tennessee. Tennessee has a population of approximately 5.7 million dispersed unevenly among 95 counties. There are 2958 Zipcodes within Tennessee and its catchment area. The catchment area producing visits to ambulatory health centers and hospitals within Tennessee includes approximately 4.0 million people, predominantly from the surrounding, immediately adjacent States. Tennessee is an archetypal example of a State having potential attractiveness and/or vulnerability to bioterrorist attack insofar as it possesses several metropolitan areas of high population (e.g., Memphis), has other metropolitan areas that are destinations for large conferences and tourism (e.g., Nashville), and also has several nuclear facilities and military weapons plants whose defenses might be more easily breached if the public health and civil infrastructure were compromised by a bioterrorist attack. FIGS. 4-11 are illustrations of example scenarios developed to explore the performance of the method of the current invention and the system embodied said method. The scenario data are recorded in the attached MICROSOFT® Excel xls spreadsheets and S-PLUS sdd files.

Although the invention has been described with reference to the preferred embodiment illustrated in the attached drawing figures, it is noted that substitutions may be made and equivalents employed herein without departing from the scope of the invention as recited in the claims. For example, additional steps may be added and steps omitted without departing from the scope of this invention.

What the invention claimed is:

1. A method in a computing environment for disease surveillance and outbreak detection, the method comprising the steps of:
accessing population and location data for a plurality of geographies;
accessing clinical data originating from a plurality of reporting units associated with the geographies, said clinical data including a count of affected persons for a predetermined time period;
calculating exponential moving averages of standardized syndromic incidence ratios for each count of affected person from each reporting unit; and
generating kriging plots and Moran I statistics, wherein a p-value is computed for each spatiotemporal pattern.

2. The method of claim 1, wherein the geographies are counties.

3. The method of claim 1, wherein the predetermined time period is a day.

4. The method of claim 1, wherein the location data includes the longitude and latitude of the each geography.

5. The method of claim 1, further comprising the step of calculating the K-nearest neighbor based on the longitude and latitude of the geographies.

6. The method of claim 1, wherein the geographies are cities.

7. The method of claim 5, wherein the exponential moving averages are calculated for a period of days corresponding to an epidemiologically optimized value reflecting the statistical distribution of incubation periods of likely agents of bioterrorism.

8. The method of claim 5, further comprising the step of performing a Freemen Tukey transformation of the incidence ratio for each reporting unit.

9. The method of claim 8, further comprising the step of performing a logit transformation of the incidence ratio for each reporting unit.

10. The method of claim 1, further comprising the step of providing an alert if the p-level is greater than or equal to a predetermined constant

11. A method in a computing environment for effecting a controlled, recurring assessment of a spatiotemporal event incidence patterns on a state or national level, the method comprising the steps of:
accessing transmissions data received from a plurality of reporting units, said transmission data including proband counts for a predefined time period;
totalizing said proband counts;
recursively calculating exponential moving averages (EMAs) of standardized syndromic incidence ratios, for each reporting unit's reported counts of proband cases;
generating kriging plots and Moran I statistics, wherein a p-value is computed for each spatiotemporal pattern, and
if the p-level is greater than or equal to a predetermined constant, initiating an alert or escalating vigilance in a particular geography.

12. The method of claim 11, further comprising the step of performing a Freeman-Tukey and logit transformation of each reporting unit's standardized daily syndromic incidence ratio, to normalize the variance and to prevent excessive sensitivity to single-count reports from reporting units having small population.

13. The method of claim 11, wherein the predefined time period is a day.

14. A system in a computerized environment for disease surveillance and outbreak detection, the system comprising:
a first accessing component for accessing population and location data for a plurality of geographies;
a second accessing component for accessing clinical data originating from a plurality of reporting units associated with the geographies, said clinical data including a count of affected persons for a predetermined time period;
a calculating component for calculating exponential moving averages of standardized syndromic incidence ratios for each count of affected person from each reporting unit; and
a generating component for generating Moran I statistics, wherein a p-value is computed for each spatiotemporal pattern.
